(19) United States
(12) Patent Application Publication
(10) Pub. No.: US 2026/0311680 A1
(43) Pub. Date: Oct. 8, 2026

(54) INFORMATION PROCESSING DEVICE

(71) Applicant: TOYOTA JIDOSHA KABUSHIKI KAISHA, Toyota-shi (JP)

(72) Inventors: Takayuki YAMABE, Tokyo (JP); Aya YAMADA KAMISAKA, Tokyo (JP); Hajime TOJIKI, Tokyo (JP); Kota HOSHIBA, Tokyo (JP); Ryota NAKANISHI, Tokyo (JP)

(73) Assignee: TOYOTA JIDOSHA KABUSHIKI KAISHA, Toyota-shi (JP)

(21) Appl. No.: 19/535,556

(22) Filed: Feb. 10, 2026

(30) Foreign Application Priority Data
Apr. 2, 2025 (JP) 2025-061427

(51) Int. Cl. G10L 13/027; G10L 15/22

(52) U.S. Cl. CPC G10L 13/027; G10L 15/22

(57) ABSTRACT

An information processing device that provides a dialogue service according to a first dialogue model associated with a first user performs estimating a second user that is scheduled to rendezvous with the first user, acquiring predetermined data related to a second dialogue model associated with the second user, based on a result of the estimation, and providing a dialogue service by the first dialogue model, using data that is acquired.

### CROSS-REFERENCE TO RELATED APPLICATION

This application claims priority to Japanese Patent Application No. 2025-061427 filed on Apr. 2, 2025. The disclosure of the above-identified application, including the specification, drawings, and claims, is incorporated by reference herein in its entirety.

### BACKGROUND

### 1. Technical Field

The present disclosure relates to dialogue technology.

### 2. Description of Related Art

A system is provided that enables dialogue by speech in a vehicle. Related to this, Japanese Unexamined Patent Application Publication No. 2001-195430 (JP 2001-195430 A), for example, discloses a system in which AI agents corresponding to users hold pseudo-conversations with each other.

### SUMMARY

With the advancement of machine learning, dialogue services through natural language are expected to become increasingly widespread.

An object of the present disclosure is to provide information with appropriate contents in a speech dialogue system.

One aspect of the embodiments of the present disclosure relates to an information processing device that provides a dialogue service according to a first dialogue model associated with a first use includes a control unit that executes estimating that the first user and a second user are scheduled to rendezvous, acquiring predetermined data related to a second dialogue model associated with the second user, based on a result of the estimation, and providing a dialogue service by the first dialogue model, using data that is acquired.

Also, other aspects include a method executed by the above device, a program that causes a computer to execute this method, and a computer-readable storage medium that stores this program in a non-transitory manner.

According to the present disclosure, information provision of appropriate contents can be performed in a speech dialogue system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a dialogue system according to a first embodiment;

FIG. 2 is a configuration diagram of an in-vehicle device according to the first embodiment;

FIG. 3 is a configuration diagram of a server device according to the first embodiment;

FIG. 4 is a diagram showing a flow of processing executed by a control unit of the in-vehicle device;

FIG. 5 is a flowchart of the processing executed by the control unit of the in-vehicle device;

FIG. 6 is a second flowchart of processing executed by the control unit of the in-vehicle device; and

FIG. 7 is an example of dialogue according to a modification.

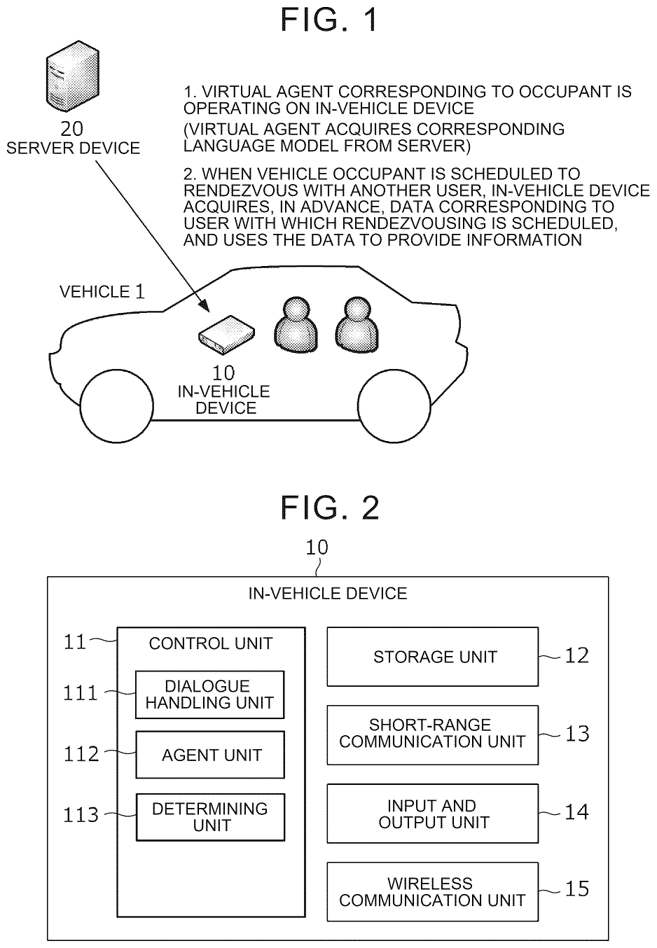

### DETAILED DESCRIPTION OF EMBODIMENTS

In recent years, with the advancement of machine learning, the number of products incorporating language models has been increasing. For example, natural language dialogue functions can be added to a target product by incorporating into the product a large language model (LLM) trained by machine learning using a large-scale dataset for improved precision.

An example in which dialogue by natural language is useful is an automobile.

For example, incorporating an LLM into an in-vehicle device enables information to be obtained without operating a touch panel or the like. Such a function is particularly useful when the hands of the user are occupied, such as while driving or the like. Also, utterances by the vehicle side enable information to be actively provided to occupants.

Attempts to personalize dialogue by providing a language model for each occupant riding in a vehicle are also underway. For example, it is anticipated that by enabling dialogue using language models that have learned personal information and personal preferences, more detailed services can be provided to vehicle occupants.

An information processing device according to a first aspect of the present disclosure is an information processing device that provides a dialogue service according to a first dialogue model associated with a first user, including a control unit that executes estimating that the first user and a second user are scheduled to rendezvous, acquiring predetermined data related to a second dialogue model associated with the second user, based on a result of the estimation, and providing a dialogue service by the first dialogue model, using data that is acquired.

The information processing device can be, for example, a device installed in the vehicle (an in-vehicle device). The information processing device can provide the dialogue service according to the first dialogue model associated with the first user (typically driver of vehicle). The first dialogue model may be a language model that has been trained with personal information and personal preferences of the first user, i.e., a language model that is personalized for the first user.

The first dialogue model may be stored in the information processing device, or may be downloaded to the information processing device from a network. Also, when the information processing device is an in-vehicle device, the first dialogue model may be copied to the in-vehicle device via a network from a mobile terminal or the like carried by a user in the vehicle, and be executed.

The control unit estimates that the first user and the second user are scheduled to rendezvous. The estimation may be performed, for example, based on information (schedule information, etc.) acquired from a mobile device carried by the first user, or may be performed based on past activities (action history) of the first user or the like.

Also, the control unit acquires predetermined data relating to the second dialogue model associated with the second user based on estimation results, and provides the dialogue service using the acquired data.

The second dialogue model is a language model that is personalized for the second user. The control unit may acquire the second dialogue model itself, or may acquire only portions of the data contained in the second dialogue model that relate to the personal data of the second user. Also, when the second dialogue model and the personal data of the second user are separated, the control unit may acquire just the personal data. Note that the data to be acquired may be limited just to data that the second user has given permission to reference.

According to this configuration, the first dialogue model can reference information regarding the second user at a timing before the first user and the second user rendezvous, thereby making enabling the first user to conduct a dialogue regarding the second user.

This configuration enables “studying a future activity schedule, taking into account preferences of the second user with which rendezvousing is scheduled”, for example.

Note that the control unit may estimate that the first user and the second user are scheduled to rendezvous, based on data relating to past activities of the first user. The data relating to the past activities of the first user is typically past action history data of the first user. For example, when there is a history of the first user meeting the second user on a particular day of the week, the control unit can use this information to estimate the day on which the first user and the second user will rendezvous.

Note that the data relating to the past activities of the first user may include schedule data, history of sending and receiving emails and messages, and so on.

Also, the second dialogue model may be a model for conducting dialogue using personal data that is knowledge regarding the second user, and the predetermined data may be the personal data.

Also, the first and the second dialogue models may be stored in a cloud server.

Typically, personal data is data that is specific to the second user, such as the personal information of the user, action history of the user, data related to preferences of the user, and so forth. Acquiring just the personal data enables communication costs and processing costs to be suppressed as compared to a case of acquiring the entire dialogue model.

The control unit may also set the second dialogue model as an object of the acquiring, and cause the first and the second dialogue models to conduct a dialogue with each other, triggered by an utterance by the first user.

When the control unit acquires the entire second dialogue model, the first dialogue model and the second dialogue model can be made to conduct a dialogue with each other. Accordingly, it can be anticipated that, for example, a certain conclusion can be reached on a certain topic (e.g., a discussion about places to stop by) simply by the first user providing an opportunity for conversation.

Hereinafter, embodiments of the present disclosure will be described with reference to the drawings. Hardware configurations, module configurations, functional configurations, and so forth, described in each embodiment are not intended to limit the technical scope of the disclosure to these configurations alone, unless otherwise specified.

### First Embodiment

### System Overview

An overview of a dialogue system according to a first embodiment will be described. The dialogue system according to the present embodiment is configured including an in-vehicle device 10 that is installed in a vehicle 1 and a server device 20.

The in-vehicle device 10 is a device that is capable of providing a dialogue service in natural language using a virtual agent. The virtual agent is a program that is capable of dialogue through natural language. Running the virtual agent in the in-vehicle device 10 so as to be resident therein enables the vehicle occupants to receive information provision services in natural language at any time.

The server device 20 is a cloud server that stores a language model used by a virtual agent running in the in-vehicle device 10.

The virtual agent can behave as different agents by loading different language models for each of a plurality of the users riding in the vehicle 1. For example, in a case in which there are four users who regularly ride in the vehicle 1, the server device 20 may store language models for the four users. In this case, the in-vehicle device 10 can download and use language models corresponding to the users riding in the vehicle. Each of the language models can access data relating to personal information, action history, and preferences of the corresponding user (hereinafter referred to as personal data), and is configured to make suggestions and so forth that are tailored to the individual. The personal data may be incorporated into the language model, or may be stored in association with the language model.

The in-vehicle device 10 is installed in a connected vehicle that is capable of communicating with any device via wireless communication. The in-vehicle device 10 may include a data communication module (DCM) for connecting components of the vehicle (e.g., an electronic control unit (ECU), an in-vehicle terminal, and so forth) to a network. The virtual agent operating in the in-vehicle device 10 can also collect information from external devices and the like, via the network.

In the present embodiment, the in-vehicle device 10 runs a virtual agent corresponding to the user (first user) riding in the vehicle, and estimates that the first user and the second user are scheduled to rendezvous, based on data regarding the first user (e.g., past action history of first user, etc.).

When it is determined that the first user is scheduled to rendezvous with the second user, the in-vehicle device 10 acquires the personal data of the second user associated with the second dialogue model associated with the second user from the server device 20 and makes it available to the virtual agent that is running.

The personal data of the second user is data that is personal regarding the second user, such as personal information, action history, and preferences of the second user, and accordingly, with this configuration, the virtual agent using a first dialogue model can reference the personal data of the second user. This also enables the virtual agent to provide the first user with topics of interest related to the second user before the first user and the second user rendezvous.

### Device Configuration

Next, configurations of devices that make up the system will be described. FIG. 2 is a diagram schematically illustrating an example of a configuration of the vehicle 1 according to the present embodiment.

The in-vehicle device 10 can be configured as a computer that has a processor (a central processing unit (CPU), a graphics processing unit (GPU), etc.), a main storage device (random-access memory (RAM), read only memory (ROM), etc.), and an auxiliary storage device (erasable programmable read only memory (EPROM), a hard disk drive, a removable medium, etc.). An operating system (OS), various types of programs, various types of tables, and so forth, are stored in the auxiliary storage device, and the programs that are stored therein are executed, whereby various functions (software modules) can be realized to meet predetermined purposes, which will be described later. Note, however, that part or all of the functions may alternatively be implemented as hardware modules by using hardware circuits such as application-specific integrated circuits (ASICs), field-programmable gate arrays (FPGAs), and so forth, for example.

The in-vehicle device 10 is configured including, as hardware, a control unit 11, a storage unit 12, a short-range communication unit 13, an input/output unit 14, and a wireless communication unit 15.

The control unit 11 is a computing unit that implements various functions of the in-vehicle device 10 by executing predetermined programs. The control unit 11 can be realized by a hardware processor such as a CPU or the like, for example. The control unit 11 may also be configured including RAM, ROM, cache memory, and so forth.

In the present embodiment, the control unit 11 of the in-vehicle device 10 is configured including three software modules, which are a dialogue handling unit 111, an agent unit 112, and a determining unit 113. Each of the software modules may be realized by executing a program stored in the storage unit 12 using the control unit 11 (CPU, etc.). Note that information processing that is executed by the software modules is synonymous with information processing that is executed by the control unit 11 (CPU, etc.).

The dialogue handling unit 111 acquires, via the input/output unit 14, utterances made by an occupant (hereinafter also referred to as user) riding in the vehicle. The dialogue handling unit 111 executes predetermined processing with regard to voice data that is acquired, and executes speech recognition. Thus, content of the utterance is converted into text. The dialogue handling unit 111 also transmits the text that is obtained from the speech recognition to the agent unit 112.

Also, the dialogue handling unit 111 outputs a response from the language model, transmitted from the agent unit 112. The dialogue handling unit 111 converts the response into a speech and performs output thereof via the input/output unit 14.

The agent unit 112 provides dialogue service using language models. The agent unit 112 can behave as virtual agents by providing dialogue services using language models.

A virtual agent may be realized by combining a program and a language model, for example. In the present embodiment, a different language model is used for each user. For example, the agent unit 112 can behave as a virtual agent for user A by using a language model corresponding to user A, and can behave as a virtual agent for user B by using a language model corresponding to user B.

In the present embodiment, these language models are stored in the server device 20.

The agent unit 112 can set up a virtual agent by downloading a language model corresponding to an object user from the server device 20.

Note that when specialized knowledge is required in the dialogue, the agent unit 112 may collect information from one or more external devices that are available via a network. For example, when determination is made that the user who made the utterance is requesting information regarding a facility or shop, the agent unit 112 may access an external language model that can provide regional information and that is accessible via a network, so as to obtain the information.

Also, based on information acquired from the determining unit 113 which will be described below, the agent unit 112 determines that the object occupant has plans to rendezvous with another user, acquires personal data regarding the other user, and thereupon provides a dialogue service with the occupant. Detailed processing will be described later.

The determining unit 113 estimates that the user corresponding to the virtual agent (user A) is scheduled to rendezvous with another user (user B), and generates an action plan. The action plan is a future action schedule estimated for user A, and may include, for example, estimated time of rendezvous with user B, an identifier of estimated users, and so forth.

Here, a situation will be supposed in which user A is riding in the vehicle 1, and the virtual agent corresponding to user A is running on the in-vehicle device 10. For example, at the timing when a dialogue using the virtual agent is started, the determining unit 113 estimates that “user A plans to rendezvous with another user within a predetermined period of time”. The determining unit 113 may acquire data (referred to as personal terminal data, examples of which include past action history, scheduler data, email and messenger transmission and reception history, and so forth,) from, for example, a personal terminal of user A in the vehicle, and based on this, may estimate an action plan of user A for the day. For example, when there is a history of user A meeting user B on a particular day, the determining unit 113 can estimate, based on the history, that user A will rendezvous with user B on that day.

When the determining unit 113 determines that user A will rendezvous with user B within a predetermined period of time, the determining unit 113 transmits the action plan that is estimated to the agent unit 112.

The storage unit 12 is means storing information, and is made up of a storage medium such as RAM, a magnetic disk, flash memory, or the like. The storage unit 12 stores programs to be executed by the control unit 11, data to be used by the programs, and so forth.

The short-range communication unit 13 is a module that communicates with a mobile terminal carried by the occupant of the vehicle 1 via short-range wireless communication. The short-range communication unit 13 can communicate with the mobile terminal carried by the occupant of the vehicle 1, using, for example, a communication standard such as Bluetooth (registered trademark) or the like.

The input/output unit 14 is a unit that receives input from the user of the device and presents information to the user. The input/output unit 14 typically configured including devices that input and output speech, such as a microphone and a speaker. The input/output unit 14 may also include a device that provides visual information (display, etc.).

The wireless communication unit 15 includes a communication module that performs wireless communication with a predetermined network (e.g., a wide area network such as the Internet, etc.). In the present embodiment, the wireless communication unit 15 is configured to be able to communicate with a predetermined mobile communication network. The wireless communication unit 15 can be configured having an embedded universal integrated circuit card (eUICC) (e.g., a SIM card). The in-vehicle device 10 can communicate with the server device 20 via the wireless communication unit 15.

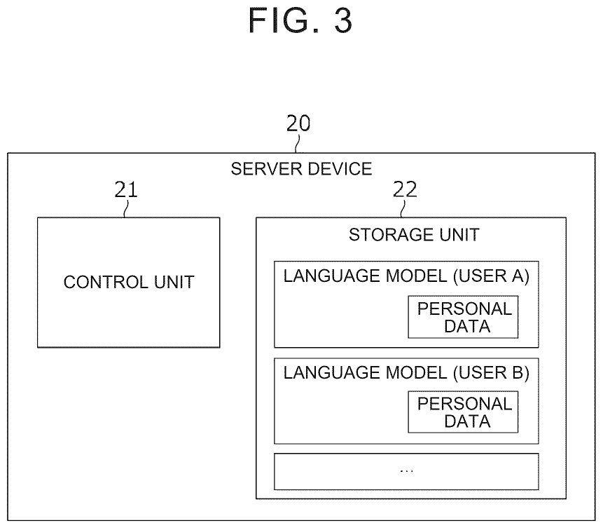

Next, the server device 20 will be described. FIG. 3 is a diagram schematically illustrating an example of a configuration of the server device 20 according to the present embodiment.

In the same way as with the in-vehicle device 10, the server device 20 can be configured as a computer having a processor (CPU, GPU, etc.), a main memory device (RAM, ROM, etc.), and an auxiliary storage device (EPROM, hard disk drive, removable media, etc.).

The server device 20 is configured having a control unit 21 and a storage unit 22, as hardware.

The control unit 21 is a computing unit that realizes various functions of the server device 20 by executing predetermined programs. The control unit 21 can be realized by a hardware processor such as a CPU or the like, for example. The control unit 21 may also be configured including RAM, ROM, cache memory, and so forth.

In the present embodiment, the control unit 21 of the server device 20 executes processing of providing a language model for a specified user in response to a request from the in-vehicle device 10.

The storage unit 22 is means for storing information, and is made up of a storage medium such as RAM, a magnetic disk, flash memory, or the like. The storage unit 22 stores language models corresponding to multiple users riding in the vehicle 1.

In the present embodiment, the language model is configured including personal data. Personal data is data specific to the user who is an owner of the language model, and is data related to personal information of the user, action history of the user, preferences of the user, and so forth. These data can be externally provided independently. Note that in the illustrated example, the personal data is included in the language model, but the personal data may be data that is independent of the language model.

### Processing Flow

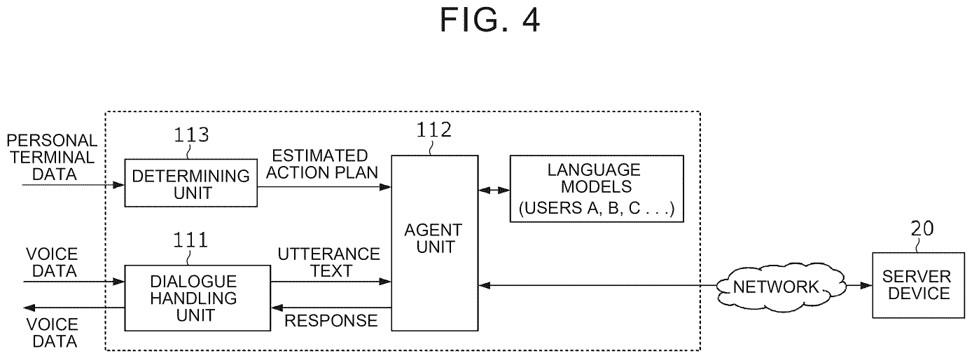

Next, an overview of the processing executed by the control unit 11 will be described. FIG. 4 is a diagram showing a flow of the processing executed by the control unit 11 of the in-vehicle device 10.

The dialogue handling unit 111 acquires utterances from the occupants of the vehicle via the input/output unit 14. For example, the input/output unit 14 converts the utterances acquired through a microphone or the like into voice data, which is then acquired by the dialogue handling unit 111. The dialogue handling unit 111 executes predetermined speech recognition processing with regard to the voice data that is acquired, and converts this voice data into text. The dialogue handling unit 111 transmits the text obtained as a result of the speech recognition to the agent unit 112, while suspending the response to the utterance. This text will be hereinafter referred to as “utterance text”.

When the content of the utterance text is to call up a virtual agent, the agent unit 112 responds to the utterance by downloading a language model corresponding to the user who made the utterance from the server device 20, and running the virtual agent. The downloaded language model is temporarily stored in the storage unit 12. It should be noted that multiple language models may be temporarily stored. Also, when the intended language model is stored in the storage unit 12, downloading can be omitted. For example, when language models corresponding to each of multiple users are stored in the storage unit 12, the agent unit 112 can instantly set up a virtual agent corresponding to the user by reading the language model to be used from the storage unit 12.

When the content of the utterance text is directed to a virtual agent, the agent unit 112 acquires a response to the utterance using the downloaded language model. For example, when the virtual agent that is currently running corresponds to user A, the agent unit 112 transfers the utterance text to the language model corresponding to user A. Note that when determination is made that the language model corresponding to user A cannot provide sufficient information, the agent unit 112 may transfer the uttered text to an external language model (remote language model) via the network.

The agent unit 112 acquires a response from this language model, and performs output thereof as voice data.

Also, the agent unit 112 receives an estimated action plan for user A from the determining unit 113, and based thereupon, acquires personal data associated with a language model corresponding to a user who is scheduled to rendezvous with user A from the server device 20.

For example, when the agent unit 112 is running a virtual agent corresponding to user A and receives an action plan from the determining unit 113 indicating that “user A is estimated to rendezvous with user B within a specified period of time,” the agent unit 112 acquires personal data of user B associated with a language model corresponding to user B from the server device 20. Personal data is data related to personal information, action history, preferences, and so forth, related to the corresponding user (limited to data that can be made public). In other words, personal data can be said to be knowledge about the user who is scheduled to rendezvous. Having the agent unit 112 acquire only personal data enables costs to be reduced as compared to a case in which the entire language model is acquired.

The agent unit 112 inputs the acquired personal data into the language model corresponding to user A as data related to the user who is scheduled to rendezvous. This enables the language model corresponding to user A to understand what kind of person user A is scheduled to rendezvous with. Accordingly, when user A performs an utterance such as, for example, “What should we go to eat now?”, the virtual agent of user A can suggest places to visit, taking into account the preferences of user B, who is estimated to be accompanying user A.

### Flowcharts

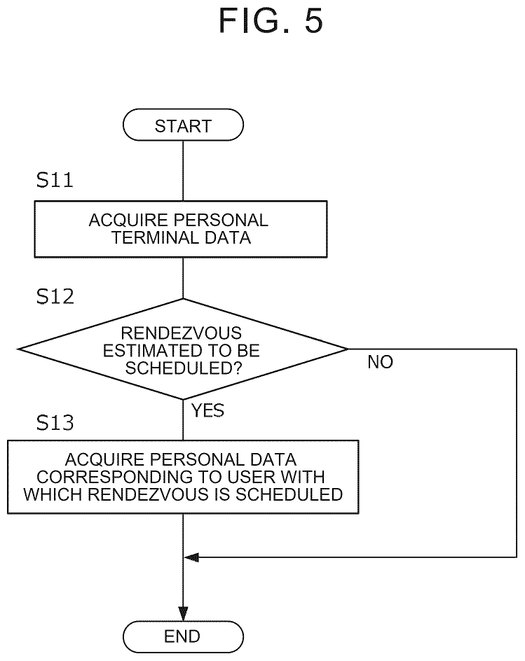

Next, the processing executed by the in-vehicle device 10 will be described in detail. FIG. 5 is a flowchart of the processing that is executed by the in-vehicle device 10. The process shown in FIG. 5 is processing of estimating an action plan of the user who is currently running the virtual agent, and acquiring personal data corresponding to the user who is scheduled to rendezvous therewith based on the estimated action plan. This processing may be executed periodically while the virtual agent is running.

First, in step S11, the determining unit 113 acquires personal terminal data. The personal terminal data can be acquired, for example, by communicating with a terminal carried by the occupant of the vehicle, via the short-range communication unit 13.

Next, in step S12, the determining unit 113 estimates, based on the personal terminal data, whether the user currently riding in the vehicle (the user corresponding to the virtual agent that is running) is scheduled to rendezvous with another user.

When estimation is made that the user riding in the vehicle is scheduled to rendezvous with another user, the processing transitions to step S13, and an estimated action plan is transmitted from the determining unit 113 to the agent unit 112. The agent unit 112 acquires, based on the action plan that is received, personal data associated with a language model corresponding to the user with who rendezvous is scheduled, from the server device 20 (step S13). When the vehicle occupant has no schedule to rendezvous with another user, the processing ends.

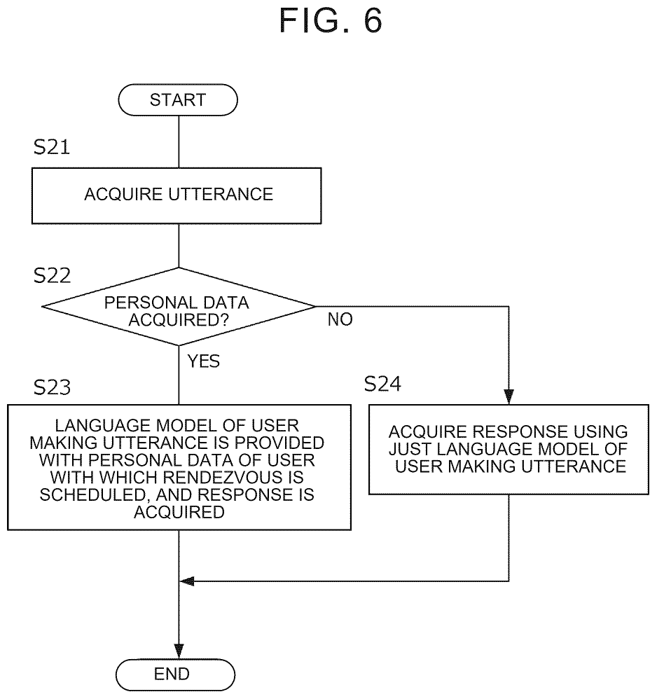

Next, details of dialogue processing will be described. The processing shown in FIG. 6 is a flowchart of dialogue processing performed by the in-vehicle device 10. This processing is initiated when an utterance is made by an occupant.

First, in step S21, the dialogue handling unit 111 recognizes the content of the utterance. The dialogue handling unit 111 acquires the voice data output from the input/output unit 14 and converts the utterance into text by executing speech recognition processing. The converted text (utterance text) is transmitted to the agent unit 112.

In step S22, the agent unit 112 determines whether personal data corresponding to the user with which rendezvous is scheduled has been acquired. When personal data corresponding to the user with which rendezvous is scheduled has been acquired, the processing transitions to step S23. In step S23, the agent unit 112 provides the personal data corresponding to the user with which rendezvous is scheduled to the language model corresponding to the user who made the utterance, and thereupon acquires a response to the utterance text.

When personal data corresponding to the user with which rendezvous is scheduled has not been acquired, the processing transitions to step S24. In step S24, the agent unit 112 acquires a response to the uttered text by using only the language model corresponding to the user who made the utterance.

### Modification of First Embodiment

In the first embodiment, the agent unit 112 acquires personal data of the user who is scheduled to rendezvous, and provides a dialogue. On the other hand, the object of acquisition may be the entire language model.

For example, in step S13 of the first embodiment, the agent unit 112 may acquire, from the server device 20, the language model itself corresponding to the user with which rendezvous is scheduled. The language model that is acquired may be stored in the storage unit 12.

Also, in the present modification, in step S22, determination is made regarding whether a language model corresponding to the user with which rendezvous is scheduled has already been acquired.

Also, in step S23, the agent unit 112 provides a dialogue using both the language model of the user who made the utterance (hereinafter referred to as “first language model”) and the language model of the user with which rendezvous is scheduled (hereinafter referred to as “second language model”). This enables a conversation to take place among the three parties of user A who made the utterance, a first language model corresponding to user A, and a second language model corresponding to user B with which rendezvous is scheduled, for example. This increases the likelihood of being able to reach a conclusion that complies with the wishes of user B, with which rendezvous is scheduled.

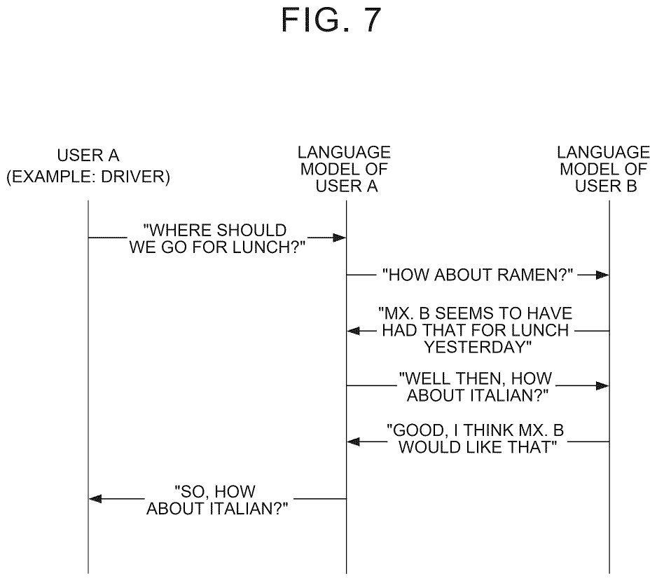

FIG. 7 shows an example of a conversation taking place among the three parties. In the example shown here, user A triggers the conversation, the first language model suggests a restaurant to have lunch at, the second language model responds to this based on the personal data of user B, and finally the first language model draws a conclusion. The conversation that takes place during this process may be output as speech via the input/output unit 14.

In this way, by involving multiple language models in a conversation, the process leading up to a conclusion can be presented to the user, and thereby enabling a more human-like dialogue to be provided.

### Modifications

The above-described embodiments are merely examples, and the present disclosure may be appropriately modified and implemented without departing from the scope thereof.

For example, the processing and means described in the present disclosure can be freely combined and implemented as long as no technical contradiction occurs.

Also, processing described as being performed by one device may be executed by being shared by a plurality of devices. Alternatively, processing described as being performed by different devices may be executed by one device. In the computer system, the hardware configuration (server configuration) can be flexibly changed for realizing each function.

The present disclosure can also be implemented by supplying a computer with a computer program that implements the functions described in the above embodiment, and causing one or more processors of this computer to read and execute the program. Such a computer program may be provided to the computer by a non-transitory computer-readable storage medium connectable to the system bus of the computer, or may be provided to the computer via a network. The non-transitory computer-readable storage medium includes, for example, a disc of any type such as a magnetic disc (floppy (registered trademark) disc, hard disk drive (HDD), etc.), an optical disc (compact disc (CD)-read-only memory (ROM), digital versatile disc (DVD), Blu-ray disc, etc.), and so forth, ROM, RAM, EPROM, electrically erasable programmable read only memory (EEPROM), a magnetic card, flash memory, an optical card, and any type of medium suitable for storing electronic commands.

What is claimed is:

1. An information processing device that provides a dialogue service according to a first dialogue model associated with a first user, the information processing device comprising:
a control unit that executes
estimating that the first user and a second user are scheduled to rendezvous,
acquiring predetermined data related to a second dialogue model associated with the second user, based on a result of the estimation, and
providing a dialogue service by the first dialogue model, using data that is acquired.

2. The information processing device according to claim 1, wherein the control unit estimates that the first user and the second user are scheduled to rendezvous, based on data relating to past activity of the first user.

3. The information processing device according to claim 1, wherein
the second dialogue model conducts dialogue using personal data that is knowledge regarding the second user, and
the predetermined data is the personal data.

4. The information processing device according to claim 3, wherein the first and the second dialogue models are stored in a cloud server.

5. The information processing device according to claim 1, wherein
the control unit
sets the second dialogue model as an object of the acquiring, and
causes the first and the second dialogue models to conducts a dialogue with each other, triggered by an utterance by the first user.
